(19) United States
(12) Patent Application Publication
(10) Pub. No.: US 2017/0282734 A1
(43) Pub. Date: Oct. 5, 2017

(54) UNMANNED AERIAL VEHICLE SELF-ALIGNING BATTERY ASSEMBLY

(71) Applicant: Skycatch, Inc., San Francisco, CA (US)

(72) Inventors: Jonathan Shyaun Noorani, Orangevale, CA (US); Samuel Giles Miller, Folsom, CA (US)

(21) Appl. No.: 15/090,437

(22) Filed: Apr. 4, 2016

(51) Int. Cl. B60L 11/18; B64D 47/08; B64F 1/00; B64C 39/02; B64C 27/04

(52) U.S. Cl. CPC B60L 11/1833; B64C 39/024; B64C 27/04; B64F 1/007; B64D 47/08; B60L 2200/10; B64C 2201/042

(57) ABSTRACT

The present disclosure is directed toward systems and methods for inserting and removing a battery assembly from an unmanned aerial vehicle (UAV) and/or a UAV ground station (UAVGS). For example, systems and methods described herein enable convenient installation of a battery assembly within a UAV. The battery assembly and UAV further include features that facilitate secure connection of the battery assembly within the UAV and which prevents wear due to frequent installation and removal of the battery assembly within a receiving slot of the UAV. In one or more embodiments, the battery assembly includes a housing and one or more connectors having one or more features that cause the battery assembly to self-align when the battery assembly is inserted within the receiving slot of the UAV.

### BACKGROUND

### 1. Technical Field

One or more embodiments of the present disclosure generally relate to unmanned aerial vehicles (UAVs). More specifically, one or more embodiments of the present disclosure relate to a battery assembly for a UAV.

### 2. Background and Relevant Art

Aerial photography and videography are becoming increasingly common in providing images and videos in various industries. For example, aerial photography and videography provides tools for construction, farming, real estate, search and rescue, and surveillance. UAVs provide an improved economical approach to aerial photography and videography over capturing photos and videos from manned aircraft or satellites.

Conventional UAVs often include different systems on board that enable different functions of the UAV. For example, UAVs typically include a power system including a power source that provides power to one or more components on the UAV. For instance, conventional UAVs often include one or more batteries that provide power to rotors and a camera onboard the UAV. In addition, UAVs often include data components on board the UAV. For example, UAVs often include memory ports, universal serial bus (USB) ports, and other data components that facilitate memory, storage, and communication capabilities of the UAV. Nevertheless, implementing power and data systems on board a UAV suffers from a number of limitations and drawbacks.

For example, while having power and data systems on board the UAV provides additional features and functionality, conventional UAVs typically require a user to service power systems and data systems on board the UAV separately. In particular, where the UAV consumes a battery, a user retrieves the UAV and replaces the battery. Additionally, where a camera, global positioning system (GPS) or other component uses up available storage or memory on the UAV, the user retrieves the UAV and replaces a hard drive, secure digital (SD) card, or other storage component on the UAV. Having separate power and data systems increases the frequency that a user must retrieve the UAV (e.g., fly the UAV to a UAV ground station (UAVGS)) and increases the frequency of maintenance required to ensure proper functionality.

In addition, common battery connectors often break or are otherwise easily damaged. In particular, installing and extracting a battery from a UAV may cause stress on one or more connections between the battery and the UAV. In particular, the connections can experience jolting or jarring movement relative to corresponding contacts. As a result, common battery connections can require replacement or repair after multiple uses.

Accordingly, there are a number of considerations to be made in with UAV batteries.

### BRIEF SUMMARY

The principles described herein provide benefits and/or solve one or more of the foregoing or other problems in the art with improved UAV battery assemblies. In particular, one or more embodiments include a battery assembly for a UAV with features that cause the battery assembly to self-align when loaded into the UAV. In particular, the housing can include one or more features that cause the housing to self-align within a receiving slot of the UAV when loaded into the UAV. For example, the housing of the battery may have a shape that causes the battery assembly to self-align as the housing fits within a receiving slot of the UAV.

In one or more embodiments, the battery assembly includes a housing with both data and power connectors (e.g., a dual-connector batter assembly). One or more of the connectors can include various features that cause the housing to further align within the receiving slot as the housing is further inserted into the receiving slot. For example, one or more of the connectors can have a shape that cause the battery assembly to further self-align as the housing slides within the receiving slot of the UAV. As such, a user or UAV ground station (UAVGS) can conveniently replace the battery assembly within a receiving slot while ensuring that the connectors form a secure connection with corresponding contacts within the UAV.

Further, one or more embodiments include features and functionality that prevent components within the battery assembly and the UAV from breaking down after multiple uses. In particular, the battery assembly and/or a receiving slot of the UAV can have a shape and corresponding engagement points that prevent breakdown of one or more connections between the battery and the UAV. For example, the housing of the battery assembly and one or more connectors on the battery assembly can have shapes that cause the battery assembly to self align within a receiving slot in a manner that prevents exposure of the connectors to damage. As a result, a user can insert and extract the battery without causing jarring between various components, thereby reducing wear and tear on the battery assembly and the UAV.

Additional features and advantages of exemplary embodiments will be set forth in the description which follows, and in part will be obvious from the description, or may be learned by the practice of such exemplary embodiments. The features and advantages of such embodiments may be realized and obtained by means of the instruments and combinations particularly pointed out in the appended claims. These and other features will become more fully apparent from the following description and appended claims, or may be learned by the practice of such exemplary embodiments as set forth hereinafter.

### BRIEF DESCRIPTION OF THE DRAWINGS

In order to describe the manner in which the above-recited and other advantages and features of the embodiments can be obtained, a more particular description of the principles briefly described above will be rendered by reference to specific embodiments thereof that are illustrated in the appended drawings. It should be noted that the figures are not drawn to scale, and that elements of similar structure or function are generally represented by like reference numerals for illustrative purposes throughout the figures. Understanding that these drawings depict only typical embodiments and are not therefore to be considered to be limiting of its scope, principles will be described and explained with additional specificity and detail through the use of the accompanying drawings.

FIG. 1 illustrates a side-perspective view of an unmanned aerial vehicle (UAV) in accordance with one or more embodiments;

FIG. 2 illustrates a side-perspective view of a UAV ground station (UAVGS) in accordance with one or more embodiments;

FIG. 3A illustrates a side-perspective view of an example dual-connector self-aligning battery assembly in accordance with one or more embodiments;

FIG. 3B illustrates a side-perspective view of an example dual-connector self-aligning battery assembly in accordance with one or more embodiments;

FIG. 3C illustrates a side cross-sectional view of an example dual-connector self-aligning battery assembly in accordance with one or more embodiments;

FIG. 3D illustrates a front view of an example dual-connector self-aligning battery assembly in accordance with one or more embodiments;

FIG. 4A illustrates a side-cross sectional view of an example dual-connector self-aligning battery self-aligning within a receiving slot in accordance with one or more embodiments;

FIG. 4B illustrates a side-cross sectional view of an example dual-connector self-aligning battery assembly further self-aligning within a receiving slot in accordance with one or more embodiments;

FIG. 4C illustrates a side-cross sectional view of an example dual-connector self-aligning battery assembly inserted within a receiving slot in accordance with one or more embodiments;

FIG. 5 illustrates a front view of another example of a dual-connector self-aligning battery assembly in accordance with one or more embodiments;

FIG. 6 illustrates a top cross-section view of an example dual-connector battery assembly in accordance with one or more embodiments;

FIG. 7 illustrates a flowchart of a series of acts in a method for inserting a dual-connector battery assembly within a UAV; and

FIG. 8 illustrates a block diagram of an exemplary computing device in accordance with one or more embodiments.

### DETAILED DESCRIPTION

One or more embodiments described herein include a self-aligning battery assembly for a UAV. In one or more embodiments, the self-aligning battery assembly includes a housing that is sized to fit into a receiving slot of a UAV or a docking station. The housing further has a shape and/or features that cause the housing to self-align within the receiving slot of the UAV or docking station. The self-aligning battery assembly can help compensate for real-world misalignments due to weather or other conditions and help prevent damage to sensitive components of the self-aligning battery assembly, the UAV, or a docking station.

One or more embodiments of the self-aligning battery assembly include both power connectors and data connectors that provide power and data capabilities to the UAV. In particular, when the self-aligning battery assembly is connected to the UAV, the single assembly can provide both power and data capabilities to respective power and data systems on the UAV. In particular, the self-aligning battery assembly includes one or more power connectors that provide power from a battery cell to one or more components on the UAV. Additionally, the self-aligning battery assembly includes one or more data connectors that provide data capabilities (e.g., memory, storage, digital communication) to the UAV. As such, rather than replacing individual batteries, hard drives, SD cards, and other storage components individually, a user or UAV ground station (UAVGS) can conveniently replace a single self-aligning battery assembly to extract and replace both data and power components.

Additionally, one or more embodiments of the self-aligning battery assembly facilitate a secure and reliable connection between the battery and the UAV by helping ensure proper alignment of the self-aligning battery assembly within a receiving slot of the UAV. In particular, the self-aligning battery assembly can include a housing having a shape that causes the self-aligning battery assembly to self-align within a receiving slot of the UAV. As a result, the self-aligning battery assembly self-aligns within the receiving slot of the UAV and helps ensure that the connectors of the self-aligning battery assembly form a secure and reliable connection with corresponding contacts within the receiving slot of the UAV.

Furthermore, the self-aligning battery assembly helps prevent wear and tear of connection components within the self-aligning battery assembly and the UAV by causing the self-aligning battery assembly to gradually self-align within one or more tolerance levels as the self-aligning battery assembly is inserted within a receiving slot of the UAV. For example, the housing can have a shape that causes the battery to self-align within a first tolerance level. Additionally, once the self-aligning battery assembly self-aligns within the first tolerance level, one or more of the connectors can engage corresponding contacts of the receiving slot and cause the self-aligning battery assembly to further self-align within a more precise tolerance level. As the self-aligning battery assembly self-aligns, each of the connectors align more precisely with a corresponding contact and prevent jarring or imprecise fitting between connectors of the self-aligning battery assembly and corresponding contacts within the receiving slot of the UAV.

The self-aligning battery assembly can allow for manual replacement and/or service by a user. Alternatively, one or more embodiments enable a UAVGS to replace and service the self-aligning battery assembly automatically without user intervention. For example, one or more embodiments of the UAVGS include a battery arm that grips a portion of the self-aligning battery assembly and removes the self-aligning battery assembly from the UAV. When the UAV boards the UAVGS, the battery arm(s) on the UAVGS grip the self-aligning battery assembly and conveniently remove the self-aligning battery assembly from the UAV. Additionally, in one or more embodiments, the UAVGS replaces the self-aligning battery assembly after the battery recharges or, alternatively, the UAVGS replaces the self-aligning battery assembly with another self-aligning battery assembly having a similar shape and features stored on the UAVGS.

Additionally, the connectors and/or housing of the battery can have various shapes and configurations that enable more convenient removal and insertion of the self-aligning battery assembly within the UAV. For example, a shape of the housing of the self-aligning battery assembly can enable insertion the self-aligning battery assembly within a receiving slot at different angles without damage to the connectors. One will appreciate in light of the disclosure herein that this can help ensure that connectors are not damaged during replacement even when the UAV is not aligned perfectly within the UAVGS.

Additionally, one or more connectors on an end of the self-aligning battery assembly can have a symmetrical organization that enables insertion of the self-aligning battery assembly within the receiving slot at different orientations while ensuring a secure and reliable connection between the connectors of the self-aligning battery assembly and corresponding contacts within the receiving slot. As such, a user or battery arm can conveniently remove and replace the self-aligning battery assembly despite misalignments and without regard to orientation.

As used herein, an “unmanned aerial vehicle” or “UAV” generally refers to an aircraft that can be piloted autonomously or remotely by a control system. For example, a “drone” is a UAV that can be used for multiple purposes or applications (e.g., military, agriculture, surveillance, etc.). In one or more embodiments, the UAV includes onboard computers that control the autonomous flight of the UAV. In at least one embodiment, the UAV is a multi-rotor vehicle, such as a quadcopter, and includes a carbon fiber shell, integrated electronics, a battery bay, a global positioning system (“GPS”) receiver, a fixed or swappable imaging capability (e.g., a digital camera), and various energy sensors or receivers.

Additionally, as used herein an “unmanned aerial vehicle (UAV) ground station,” “ground station,” “base station,” or “UAVGS” can refer interchangeable to a landing apparatus that receives and docks a UAV. For example, a UAVGS can include a box that includes a landing cone, battery replacement system, data transfer system, communication system, etc. In one or more embodiments, a UAVGS corresponds to a particular UAV. Alternatively, a UAVGS can serve as a docking station for any number of UAVs having particular shapes or dimensions. Additionally, as will be described in greater detail below, a UAVGS can include a battery replacement system that removes, inserts, and otherwise replaces one or more battery assemblies that provide power to a UAV.

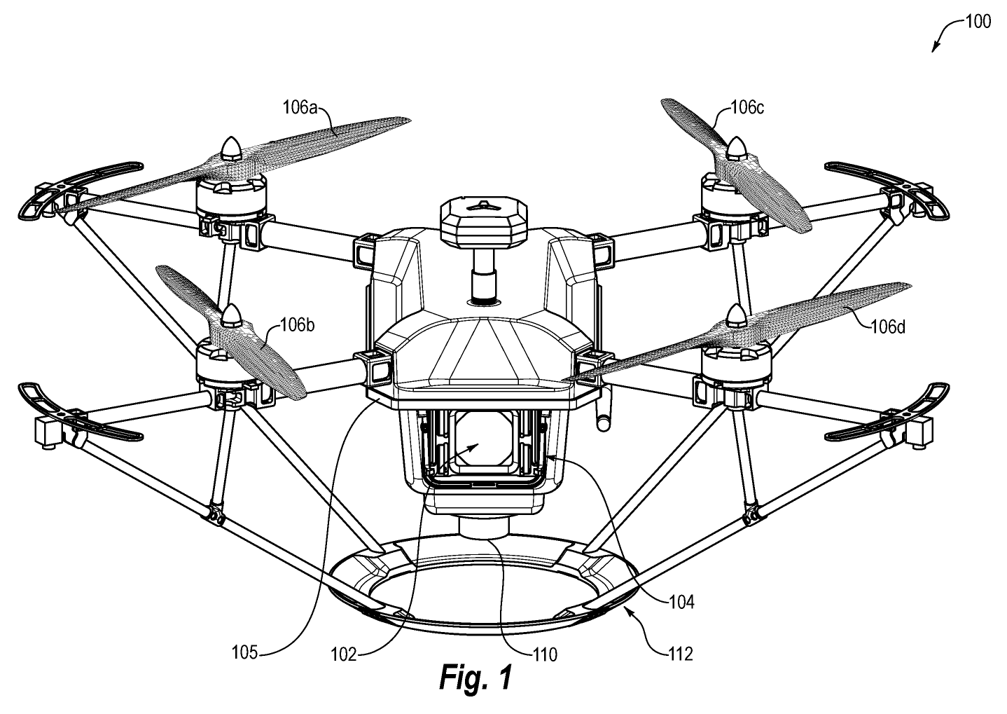

FIG. 1 illustrates one embodiment of a UAV 100. As mentioned above, and as illustrated in FIG. 1, the UAV 100 is an aircraft that is piloted autonomously or remotely by a control system. In general, UAVs can include onboard computers that control flight of the UAV. For example, the UAV 100 can include at least one processor that executes instructions that cause the UAV 100 to perform one or more processes. In one or more embodiments, the UAV 100 includes a controller that comprises special-purpose hardware, such as a special-purpose processing device that enables the UAV 100 to fly and land (e.g., dock with a UAVGS). Additionally or alternatively, components of the UAV 100 comprise a combination of computer-executable instructions and hardware. In one or more embodiments, the UAV 100 includes native applications installed thereon that enable the UAV to fly and land.

As illustrated in FIG. 1, the UAV 100 includes a self-aligning battery assembly 102 installed within a receiving slot 104 of the UAV 100. In particular, the UAV 100 includes an outer shell 105 that houses a receiving slot 104 having a size and shape to receive the self-aligning battery assembly 102. While FIG. 1 illustrates one embodiment of a UAV 100 that includes a single self-aligning battery assembly 102, it is appreciated that the UAV 100 can include multiple receiving slots 104 (e.g., within the outer shell 105) that are sized to receive more than one self-aligning battery assembly 102.

The self-aligning battery assembly 102 can provide power to one or more components on the UAV 100. For example, as shown in FIG. 1, the UAV 100 includes a plurality of rotors 106a-d supported by respective rotor arms. In particular, the rotors 106a-d enable the UAV 100 to fly at various speeds and altitudes. In one or more embodiments, the UAV 100 varies the speed and angle of one or more of the rotors 106a-d to cause the UAV 100 to change direction, altitude, and/or speed in accordance to instructions provided to the UAV 100 by a user and/or control system. While FIG. 1 shows one embodiment in which the UAV 100 includes four rotors 106a-d, it is appreciated that the UAV 100 can include any number of rotors that enable the UAV 100 to fly from one point to another at various speeds and altitudes.

In addition to providing power to the rotors 106a-d, the self-aligning battery assembly 102 can provide power to a camera 110 on board the UAV 100. In one or more embodiments, the camera 110 is positioned on an underside of the outer shell 105 to provide a view downward from the UAV 100. In particular, the camera 110 captures photos or videos of images below the UAV 100. Additionally, the camera 110 can rotate with respect to the UAV 100 and capture photos or videos from various angles and perspectives. While FIG. 1 shows one camera 110 on board the UAV 100, it is appreciated that the UAV 100 can include multiple cameras.

As shown in FIG. 1, the UAV 100 includes a landing system 112. In one or more embodiments, the landing system 112 includes a base and one or more support bars extending toward the rotors 106a-d. The landing system 112 provides structural support for the rotors 106a-d and other components of the UAV 100. Additionally, the landing system 112 provides an engagement point between the UAV 100 and a UAVGS when the UAV 100 lands. In one or more embodiments, the landing system 112 includes a conical base that engages with a UAVGS and settles within an opening of the UAVGS sized and shaped to receiving the landing system 112 of the UAV 100.

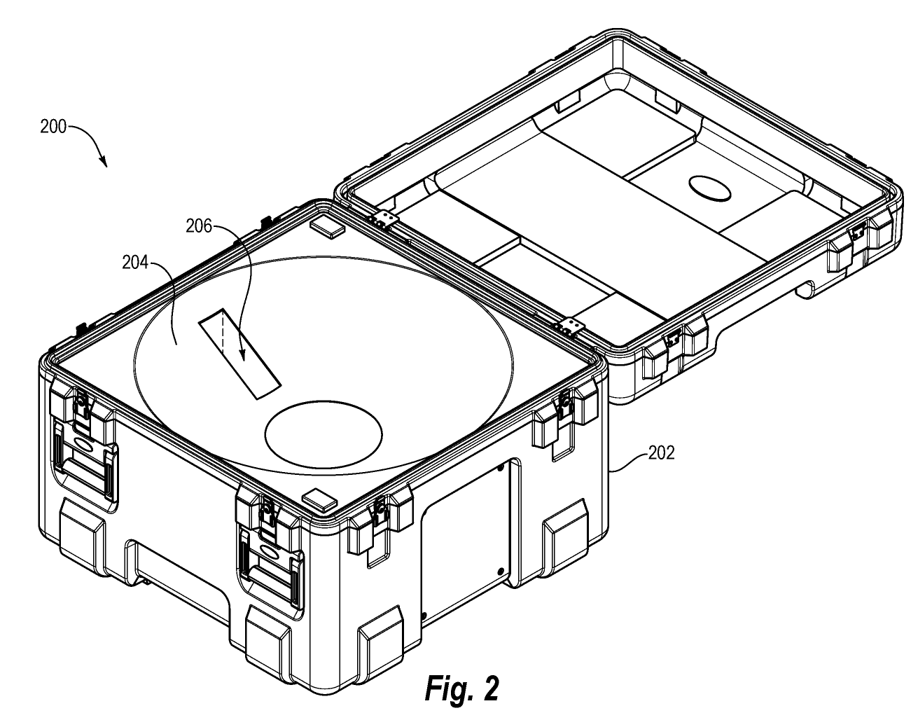

As discussed above, the UAV 100 can land and interface with an unmanned aerial vehicle ground station (UAVGS). For example, FIG. 2 illustrates an example unmanned aerial vehicle ground station 200 (or simply “UAVGS 200”). Similar to the UAV 100, the UAVGS 200 can include onboard computers that control takeoff, landing, and flight of the UAV 100. For example, similar to the UAV 100, the UAVGS 200 can include at least one processor that receives and executes instructions and cause the UAVGS 200 to perform one or more processes. In one or more embodiments, the UAVGS 200 includes special-purpose hardware, such as a special-purpose processing device that enables the UAVGS 200 to facilitate takeoff and landing of the UAV 100. Additionally, the UAVGS 200 can include one or more software and/or hardware devices that enable the UAVGS 200 to insert, remove, and replace batteries within the UAV 100 and otherwise service the UAV 100.

As illustrated in FIG. 2, the UAVGS 200 includes a housing 202 that encloses and provides a casing for various components of the UAVGS 200. Additionally, as illustrated in FIG. 2, the UAVGS 200 includes a landing cone 204 that receives a UAV 100 within the housing 202 of the UAVGS 200. As shown in FIG. 2, the landing cone 204 has a shape and size that corresponds to a shape and size of the landing system 112 of the UAV 100. For example, the landing cone 204 can have a conical shape that receives a corresponding conical shape of the landing system 112 of the UAV 100 and causes the UAV 100 to align within the UAVGS 200 as the UAV 100 lands on the UAVGS 200. Alternatively, the landing cone 204 can have any shape capable of receiving the landing system 112 of the UAV 100.

Additionally, the UAVGS 200 can include one or more engagement points within the UAVGS 200 that secure the UAV 100 in place within the landing cone 204 of the UAVGS 200. In particular, the UAVGS 200 can include one or more components that hold, fasten, or otherwise secure the UAV 100 within the landing cone 204 of the UAVGS 200. As an example, the UAVGS 200 can include one or more magnets, grooves, rails, or various mechanical components included within the UAVGS 200 that secure the UAV 100 in place within the UAVGS 200. Alternatively, the UAV 100 can include one or more components that secure the UAV 100 within the landing cone 204 of the UAVGS 200.

Additionally, as mentioned above, the UAVGS 200 can automatically retrieve and replace self-aligning battery assemblies 102 from the UAV 100. For example, as shown in FIG. 2, the UAVGS 200 includes an opening 206 having a shape and size to allow a battery arm to access a self-aligning battery assembly 102 on a UAV 100. While the UAVGS 200 shows a single opening 206, it is appreciated that the UAVGS 200 can include multiple openings of similar shapes and sizes. For example, the UAVGS 200 can include multiple opening spaced around the receiving cone 204.

In one or more embodiments, the UAVGS 200 includes a battery arm that transfers a self-aligning battery assembly 102 from the UAV 100 to the UAVGS 200 or, alternatively, from the UAVGS 200 to the UAV 100. For example, the UAVGS 200 can include one or more mechanical arms capable of gripping a self-aligning battery assembly 102 and transferring the self-aligning battery assembly 102 between the UAVGS 200 and the UAV 100. In particular, when the UAV 100 lands within the receiving cone 204 of the UAVGS, a battery arm can grip a potion of the self-aligning battery assembly 102 and remove the self-aligning battery assembly 102 from the UAV 100 and insert the self-aligning battery assembly 102 within the opening 206 of the UAVGS 200. After the self-aligning battery assembly 102 has charged, the battery arm can grip the self-aligning battery assembly 102, remove the self-aligning battery assembly 102 from a battery dock within the UAVGS 200 and place the self-aligning battery assembly 102 within a receiving slot 104 of the UAV 100. Alternatively, rather than waiting for the self-aligning battery assembly 102 to charge, the battery arm can select another self-aligning battery assembly 102 (e.g., another battery that has already charged) from a battery dock on the UAVGS 200 and place the replacement self-aligning battery assembly 102 within the UAV 100. For example, U.S. patent application Ser. No. 14/971,738 includes one example of a battery arm. The entire contents of U.S. patent application Ser. No. 14/971,738 are hereby incorporated by reference in their entirety.

The UAVGS 200 can further include one or more contacts that engage with corresponding connectors on the self-aligning battery assembly 102. For example, the UAVGS 200 can include one or more power contacts that engage with power connectors on the self-aligning battery assembly 102 and one or more data contacts that engage with data connectors on the self-aligning battery assembly 102. Additionally, the UAVGS 200 can include a battery dock that has a similar size and shape as a receiving slot 104 within the UAV 100 that facilitates self-alignment of the battery 100 within the battery dock of the UAVGS 200. Additionally, when a self-aligning battery assembly 102 is installed within a battery dock of the UAVGS 200, the battery dock can facilitate recharging of a battery cell of the self-aligning battery assembly 102 via the power contacts in addition to accessing one or more data components of the self-aligning battery assembly 102 via the data contacts. For example, the UAVGS 200 can access one or more data contacts on the self-aligning battery assembly 102 and download, upload, store, or transfer data to one or more external devices (e.g., via a wireless network).

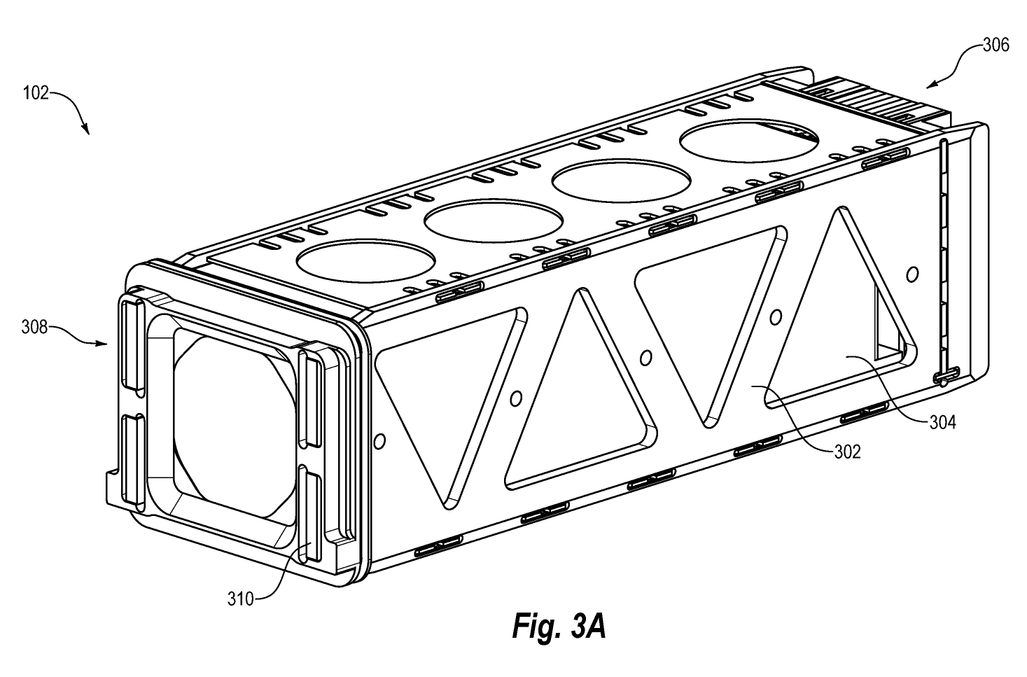

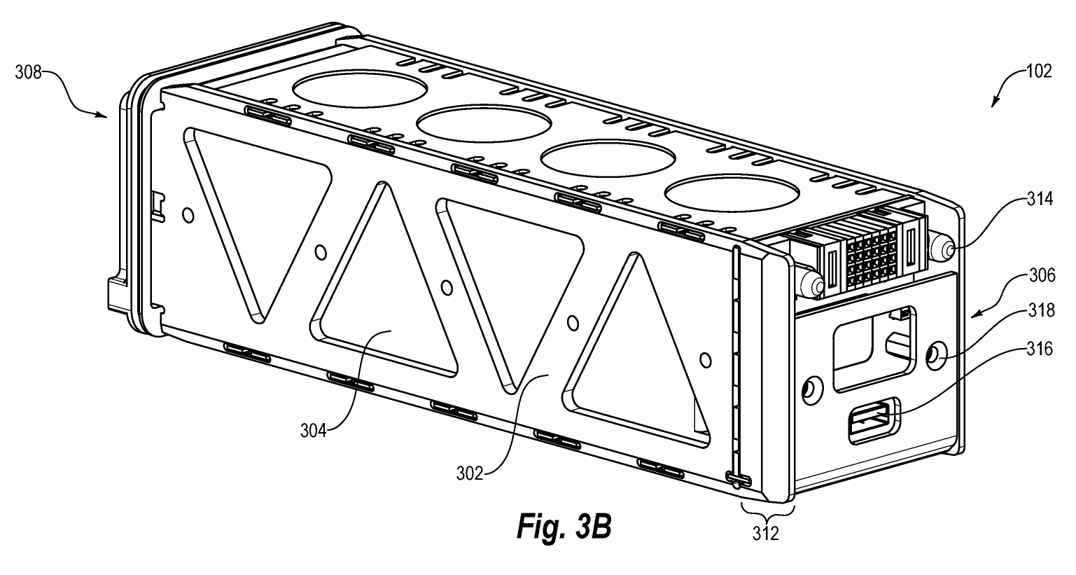

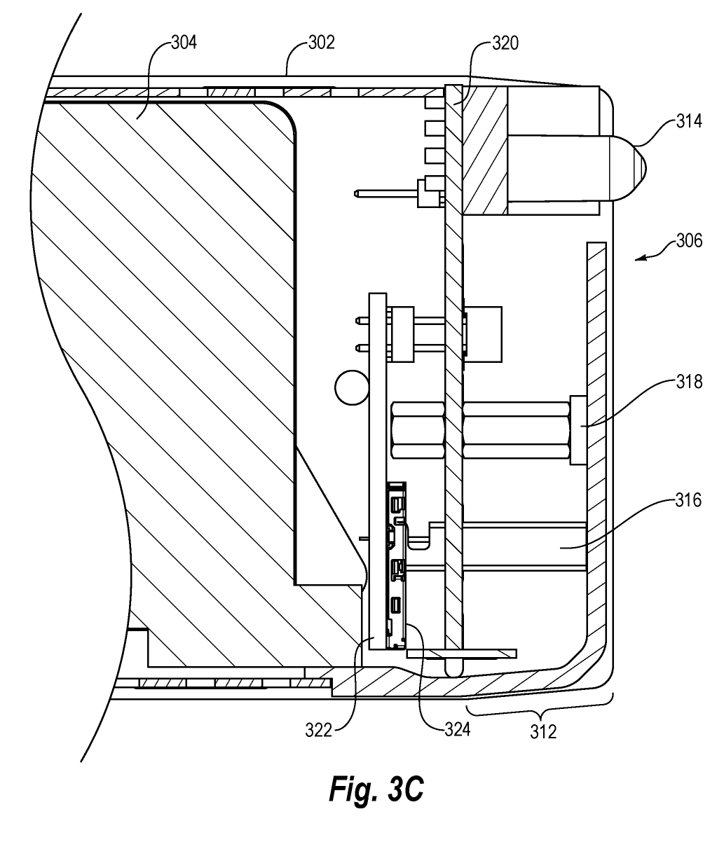

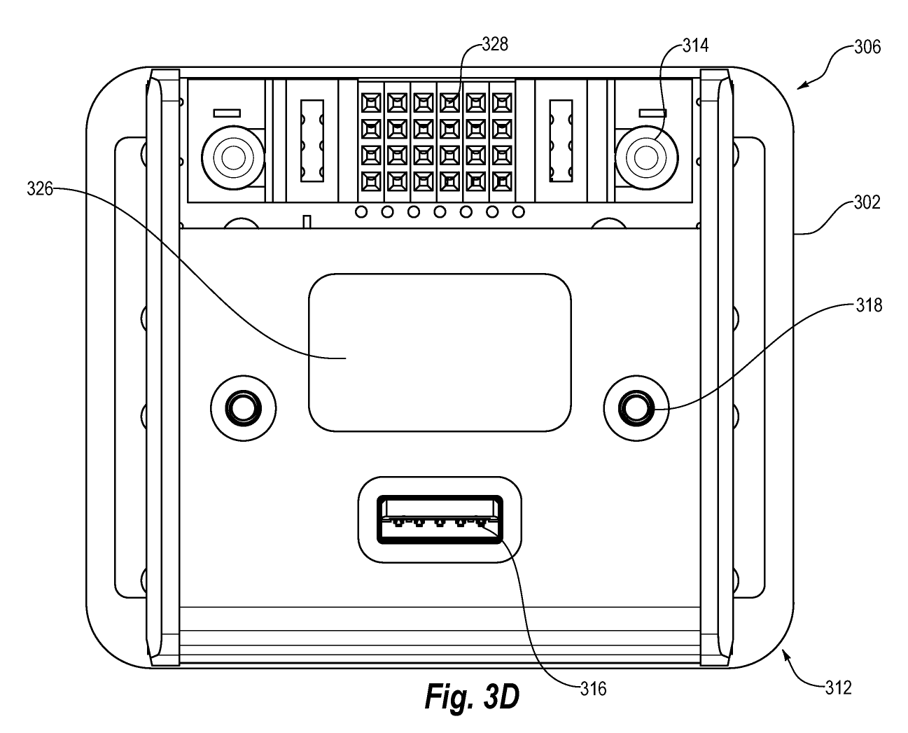

FIGS. 3A-3D illustrate multiple views of a dual-connector self-aligning battery assembly 102 (or simply “self-aligning battery assembly 102”). As shown in FIG. 3A, the self-aligning battery assembly 102 includes a housing 302 that encloses a battery cell 304. Additionally, the housing 302 includes a connection end 306 and a back end 308 that defines a body of the self-aligning battery assembly 102. The housing 302 has a shape and size that corresponds to a shape and size of the receiving slot 104 on the UAV 100 that receives the self-aligning battery assembly 102 and secures the self-aligning battery assembly 102 within the UAV 100.

As mentioned above, the self-aligning battery assembly 102 fits within a receiving slot 104 of the UAV 100. For example, as shown in FIG. 3A, the connection end 306 of the housing 302 inserts within an opening of a receiving slot 104 and slides into the receiving slot 104 until the connection end 306 engages an inner portion of the receiving slot 104. Once inserted within the receiving slot 104, the back end 308 may remain visible or otherwise accessible to a user or battery arm with the remainder of the housing 302 inserted within the receiving slot 104. In one or more embodiments, a user or battery arm engages the self-aligning battery assembly 102 via a gripping portion of the back end 308 of the housing 302.

Additionally, as shown in FIG. 3A, the self-aligning battery assembly 102 includes one or more handles 310 on the back end of the housing 302. In one or more embodiments, a user grips the self-aligning battery assembly 102 by the handles 310 and slides the battery in or out of the receiving slot 104. Alternatively, in one or more embodiments, the UAVGS 200 includes a battery arm that engages a portion of the back end of the housing 302 and causes the self-aligning battery assembly 102 to slide in or out of the receiving slot 104.

FIG. 3A shows one embodiment of the self-aligning battery assembly 102 including a housing 302 having a rectangular shape. In particular, the self-aligning battery assembly 102 illustrated in FIG. 3A includes a housing 302 having an elongated rectangular prism shape. It is appreciated that the housing 302 can have any three-dimensional shape having a connection end 306 and a back end 308. For example, the housing 302 can have a cubic, triangular prism, or cylinder shape that encloses a battery cell 304 having a similar or different shape as the housing 302. Additionally, as mentioned above, the receiving slot 104 within the UAV 100 can have a similar variety of shapes corresponding to a shape of the housing 302 and capable of receiving the housing 302 within the receiving slot 104.

FIG. 3B illustrates another view of the self-aligning battery assembly 102. In particular, FIG. 3B provides a view of the self-aligning battery assembly 102 that shows the connection end 306 of the housing 302. For example, as shown in FIG. 3B, the connection end 306 includes one or more components that engage with a receiving slot 104 of a UAV 100. In particular, the housing 302 can include one or more alignment rails 312 toward the connection end 306 of the housing 302. Additionally, the self-aligning battery assembly 102 can include one or more power connectors 314 and one or more data connectors 316 on the connection end of the housing 302. Further, the self-aligning battery assembly 102 includes one or more securing points 318 that provide a secure connection between the housing 302 and a UAV 100.

As shown in FIG. 3B, the housing 302 of the self-aligning battery assembly 102 includes an alignment rail 312 that engages with the receiving slot 104 of the UAV 100. In particular, the alignment rail 312 can cause the housing 302 of the self-aligning battery assembly 102 to self-align within the receiving slot 104 such that the power connectors 314 and the data connectors 316 are more closely aligned with corresponding contacts within the receiving slot 104 that the connectors 316, 318 engage when the self-aligning battery assembly 102 is completely inserted within the receiving slot 104 of the UAV 100.

As shown in FIG. 3B, the alignment rail 312 curves inward from an outside surface or edge of the housing 302. For example, the bottom of the housing 302 includes an alignment rail 312 that slants inward from a bottom surface of the housing 302 toward the middle of the housing 302. Additionally, the top of the housing 302 includes an alignment rail 312 that slants inward from a top surface of the housing 302 toward the middle of the housing 302. It is appreciated that any surface or outer edge of the housing 302 can include an alignment rail 312 that slants inward from an outer surface (e.g., top, bottom, side, corner) of the housing 302 towards an inner portion of the housing 302.

The slanting shape of the alignment rail 312 provides smaller dimensions of the connection end 306 than corresponding dimension(s) of the back end 308. In particular, as shown in FIG. 3B, the alignment rail 312 causes the connection end 306 of the housing 302 to have smaller dimensions than the back end 308 of the housing 302. More specifically, when viewing a top-down cross sectional view of the back end 308, the top, bottom, and/or sides of the back end 308 may each have larger dimensions than corresponding top, bottom, and/or sides of the connection end 306 when viewing a top-down cross section view of the connection end 306. In other words, the alignment rail 312 can cause the top, bottom, and/or sides of the housing 302 at the connection end 306 to be smaller than corresponding top, bottom, and/or sides of the housing 302 at the back end 308.

As mentioned above, the alignment rails 312 cause the housing 302 to self-align within the receiving slot 104 of a UAV 100 (or battery dock of a UAVGS 200). In particular, upon insertion of the self-aligning battery assembly 102 within the receiving slot 104, the alignment rail 312 comes into contact with one or more sides, rails, or other engagement points within the receiving slot 104 and causes the housing 302 to align within the receiving slot 104. For example, the alignment rails 312 causes the housing 302 to align within a first tolerance level within the receiving slot 104. In one or more embodiments, the first tolerance level refers to alignment within 1/10 of an inch of perfect alignment of the power connectors 314 with a corresponding power contact and the data connectors 316 with a corresponding data contact. As such, when the housing 302 falls within a first tolerance level, the housing 302 is within 1/10 of an inch of having a perfect alignment between the connectors 314, 316 and corresponding contacts within the receiving slot 104.

As shown in FIG. 3B, the alignment rails 312 that slant inward toward the connection end 306 of the housing 302 can cause the housing 302 of the self-aligning battery assembly 102 to self-align within the receiving slot 104 after the housing 302 is inserted most of the way within the receiving slot 104. Alternatively, rather than having an alignment rail 312 that only slants inward over a short portion of the housing 302 towards the connection end 306, one or more embodiments of the alignment rail 312 spans over a larger portion of the housing 302. For example, the alignment rail 312 can include a slanted portion of one or more edges or corners of the housing 302 that span from the back end 308 toward the connection end 306 over the entire portion or a majority portion of the housing 302. As such, the alignment rail 312 can cause the housing 302 of the self-aligning battery assembly 102 to gradually self-align within the receiving slot 104 from when the connection end 306 is inserted within an opening of the receiving slot 104 to when the housing 302 is completely (or nearly completely) inserted within the receiving slot 104. As such, the alignment rail 312 can cause the housing 302 to gradually self-align within the first tolerance level throughout the process of inserting the housing 302 within the receiving slot 104.

In one or more embodiments, the housing 302 includes multiple alignment rails 312 along an edge or corner of the housing 302. For example, rather than having a single alignment rail toward the connector side 306 of the housing 302, the housing can include multiple alignment rails 312 between the back end 308 and the connection end 306 that cause the housing 302 to incrementally slant inward from the back end 308 toward the connection end 306. When inserting the housing 302 within a receiving slot 104, the incremental alignment rails 312 can cause the housing 302 to incrementally self-align over multiple stages within the receiving slot 104 of the UAV 100. For example, each alignment rail 312 can cause the housing 302 to self-align within any number of incremental tolerance levels as the housing 302 is inserted within the receiving slot 104. As such, the shape of the housing 302 can cause the housing 302 to self-align within incremental stages of alignment from when the connection end 306 of the housing 302 is inserted within the receiving slot 104 to when the housing 302 is completely (or nearly completely) inserted within the receiving slot 104.

In addition to the alignment rail 312, the self-aligning battery assembly 102 can include one or more connectors 314, 316 that cause the self-aligning battery assembly 102 to further self-align within the receiving slot 104 of the UAV 100. For example, as shown in the side-cross-sectional view of the self-aligning battery assembly 102 of FIG. 3C, the connection end 306 of the housing 302 can include a power connector 314 and a data connector 316 facing outward from the connection end 306 of the housing 302. While FIGS. 3A-3D show one embodiment of the self-aligning battery assembly 102 that includes two power connectors 314 and a single data connector 316, it is appreciated that the self-aligning battery assembly 102 can include any number of power connectors 314 and data connectors 316 positioned on the connection end 306 of the housing 302.

Additionally, as shown in FIG. 3C, the power connectors 314 protrude from an outward surface of the connection end 306 of the housing 302. In particular, the power connectors 314 extend beyond an outer surface (e.g., a surface of a distal end) of the connection end 306 of the housing 302 such that the power connector 314 engages a corresponding power contact of the receiving slot 104 prior to any other connectors of the housing 302 engaging one or more contacts within the receiving slot 104 of the UAV 100. In one or more embodiments, the power connector 314 extends from the outward surface of the connection end 306 beyond a point of engagement of one or more data connectors 316 such that one or more of the power connectors 314 engage corresponding power contact(s) prior to one or more data connectors 316 engaging corresponding data contacts.

The combination of the alignment rail 312 and the power connector 314 cause the self-aligning battery assembly 102 to incrementally self-align within the receiving slot 104 of the UAV 100. For example, as mentioned above, the alignment rail 312 causes the housing 302 of the self-aligning battery assembly 102 to align within a first tolerance level. In one or more embodiments, the first tolerance level refers to a specific measurement of preciseness that the housing 302 is aligned within the receiving slot 104. For example, the first tolerance level can refer to an alignment of the housing 302 within 1/10 of an inch of perfect alignment between the connectors 314, 316 and corresponding contacts. Alternatively, the first tolerance level can refer to an alignment of the housing 302 within an acceptable range of error for one or more particular connectors of the self-aligning battery assembly 102. For example, the first tolerance level can refer to a range of acceptable error for aligning the power connector 314 with a corresponding power contact. More specifically, the first tolerance level can refer to a range of alignment in which the power connector 314 is adequately aligned with a corresponding power contact.

Once the power connectors 314 are aligned within an acceptable range (e.g., the first tolerance level) of corresponding power contacts, the power connectors 314 can engage the corresponding power contacts as the self-aligning battery assembly 102 is inserted within the receiving slot 104. In particular, after the housing 302 engages the receiving slot 104 via the alignment rail 312 and prior to completing installation of the self-aligning battery assembly 102 within the receiving slot 104, the power connectors 314 can engage corresponding power contacts and form an electrical connection between the power connectors 314 and the power contacts. Additionally, the shape of the power connectors 314 can cause the battery housing 302 to further self-align more precisely within the receiving slot 104.

For example, the power connectors 314 cause the housing 302 to self-align from within the first tolerance level to within a second tolerance level. As mentioned above, the second tolerance level refers to a more precise range of alignment than the first tolerance level. For instance, where the first tolerance level refers to an alignment within 1/10 of an inch of perfect alignment between the connectors 314, 316 and corresponding contacts within the receiving slot 104, the second tolerance level can refer to an alignment within 1/100 or 1/1000 of an inch of perfect alignment between the connectors 314, 316 and corresponding contacts within the receiving slot 104. In one or more embodiments, the second tolerance level are more precise than the first tolerance level by a factor of 10 or more.

Similar to the first tolerance level, a second tolerance level can refer to a specific measurement of preciseness that the housing 302 is aligned within the receiving slot 104. For example, the second tolerance level facilitated by the power connectors 314 can refer to an alignment of the housing 302 within 1/1000 of an inch of perfect alignment between the connectors 314, 316 and corresponding contacts. Alternatively, the second tolerance level can refer to the alignment of the housing 302 within an acceptable range of error for one or more connectors of the self-aligning battery assembly 102 other than the power connectors 314 that engage with corresponding power contacts prior to other connectors within the batter 102. For example, the second tolerance level can refer to a range of acceptable error for aligning a data connector 316 with a corresponding data contact. More specifically, the second tolerance level can refer to a range of alignment within which the data connector 316 is adequately aligned with a corresponding data contact.

As illustrated in FIG. 3C, the data connector 316 extends inward from an outer surface of the connection end 306 of the housing 302. For example, as shown in FIGS. 3B-3C, the data connector 316 includes a USB port shaped to receive a standard USB connector. In one or more embodiments, rather than a USB port, the data connector 316 includes a recess or hole within the housing 302 shaped to receive a plug, jack, or other type of contact that plugs into the data connector 316 and forms an electrical connection between the data connector 316 and corresponding data contact. Additionally, while one or more data connectors 316 extend inward from an outer surface of the connection end 306, one or more data connectors 316 can extend outward (e.g., protrude) from the outer surface of the connection end 306 without extending beyond the power contacts 314. For example, one or more data connectors 316 can protrude outward from the connection end 306 similar to the power connector 314 without extending beyond an outer portion of the power connector 314 that initially engages a corresponding power contact and causes the housing 302 to self-align within the receiving slot 104.

In one or more embodiments, the data connector 316 has a predetermined range of alignment that is more precise than a range of alignment for the power connector 314. For example, the power connector 314 may form a secure and reliable connection with a corresponding power contact when the housing 302 is aligned within a first tolerance level. Nevertheless, while the first tolerance level may fall within an acceptable range of alignment for the power connectors 314, the first tolerance level may not meet a predetermined range of alignment for the data connector 316 and result in wear and tear between the data connector 316 and corresponding data contact and/or an unreliable or non-secure connection between the data connector 316 and corresponding data contact without further alignment of the housing 302. In one or more embodiments, the data connector 316 has a predetermined range of alignment that corresponds with the second tolerance level accomplished using self-aligning features of the self-aligning battery assembly 102.

As such, the self-aligning battery assembly 102 can self-align within a receiving slot 104 of a UAV 100 using one or more alignment rails 312 as well as the shape and position of one or more connectors 314, 316 within the self-aligning battery assembly 102. For example, as the housing 302 is inserted within a receiving slot 104, the alignment rail 312 can cause the housing 302 to self-align from an initial alignment (e.g., an alignment of the housing 302 upon initial insertion of the connection end 306 within an opening of the receiving slot 104) to an alignment within a first tolerance level as the housing 302 is inserted into the receiving slot 104. Additionally, once the housing 302 self-aligns within the receiving slot 104 within the first tolerance level, the power connectors 314 can engage with corresponding power contacts and cause the housing 304 to further self-align within a more precise second tolerance level as the housing 302 continues to slide into the receiving slot 104. Further, once the housing 302 self-aligns within the second tolerance level, one or more data connectors 316 can engage with corresponding data contacts as the housing 302 is completely inserted within the receiving slot 104.

Further, as mentioned above, and as shown in FIGS. 3B-3C, one or more embodiments of the self-aligning battery assembly 102 further include one or more securing points 318 that secure the housing 302 to the receiving slot 104 of the UAV 100. For example, as shown in FIGS. 3B-3C, the housing 302 can include multiple securing points 318 having size and shape to receive a screw, pin, or other securing object that provides a secure connection between the self-aligning battery assembly 102 and the receiving slot 104 of the UAV 100. In addition to the power connectors 314 and the data connectors 316, the securing points 318 can provide additional stability between the self-aligning battery assembly 102 and the receiving slot 104 that prevents wear and tear or unreliability in the connection between the connectors 314, 316 and corresponding contacts.

In addition to causing the self-aligning battery assembly 102 to self-align when inserted within a receiving slot 104, the various connectors 314, 316 of the self-aligning battery assembly 102 can couple one or more components within the self-aligning battery assembly 102 to components onboard the UAV 100. In particular, as shown in FIG. 3C, the power connector 314 is coupled to one or more circuit boards 320, 322 within the battery housing 302. For example, as illustrated in FIG. 3C, the power connector 314 is coupled to a circuit board 320. In one or more embodiments, the circuit board 320 is a printed circuit board (PCB) that routes a power signal between different components within the self-aligning battery assembly 102.

Additionally, as illustrated in FIG. 3C, the data connector 316 is connected to another circuit board 322. Additionally, as shown in FIG. 3C, the circuit board 322 includes one or more data storages 324 on the circuit board 322. The data connector 316 can couple the data storages 324 to a camera or other component on the UAV 100 that utilizes the storage space on the data storages 324 when the self-aligning battery assembly 102 is installed within the receiving port 104 on the UAV 100. As described above, having the battery cell 304 and the data storages 324 within the housing 302 of the self-aligning battery assembly 102 can facilitate convenient replacement and maintenance of the self-aligning battery assembly 102 and/or the UAV 100.

In addition to the power connectors 314, the data connector 316, and securing points 318, the self-aligning battery assembly 102 can include one or more additional connectors and engagement points that couple the self-aligning battery assembly 102 to the UAV 100. For example, as shown in FIG. 3D, the housing 302 can include an opening 326 on an outside surface of the connection end 306 of the housing 302 that provides an additional engagement point between the self-aligning battery assembly 102 and the receiving port 104. For example, the opening 324 can engage a plug, contact, or other structural component on the receiving slot 104 that further secures the self-aligning battery assembly 102 in place within the receiving slot 104.

Additionally, as shown in FIG. 3D, the self-aligning battery assembly 102 includes an additional connector 328 having a size and shape to engage a corresponding contact or connector. As an example, the connector 328 can include a USB, thunderbolt, Ethernet, High Definition Multimedia Interface (HDMI), MagSafe port, video graphics array (VGA), digital video interface (DVI), or other type of standard or customized connector 328 that couples one or more components within the self-aligning battery assembly 102 to one or more components on the UAV 100. In one or more embodiments, the connector 328 provides another type of data connector (or power connector) in addition to other data connectors 316 described herein. As such, the self-aligning battery assembly 102 can include multiple types of data connectors including, for example, one or more customized data connectors 316 unique to the battery 104 and the UAV 100 and/or one or more data connectors 328 having specifications in accordance with industry standards.

In one or more embodiments, certain connectors on the self-aligning battery assembly 102 connect to corresponding contacts within the receiving slot 104 on the UAV 100. Additionally or alternatively, certain connectors on the self-aligning battery assembly 102 can connect to corresponding contacts within a similarly sized receiving slot 104 on the UAVGS 200. For example, the power connectors 314 and the data connectors 316 can connect to corresponding contacts within a receiving slot 104 on the UAV 100 while additional connectors 326, 328 connect to corresponding contacts or connections on the UAVGS 200. In one or more embodiments, the UAV 100 and the UAVGS 200 utilizes some or all of the same connectors on the self-aligning battery assembly 102. Alternatively, the UAV 100 and the UAVGS 200 may utilize different subsets of connectors on the connection end 306 of the housing 302. For example, in one or more embodiments, the UAV 100 utilizes the power connectors 314 and the data connector 316 while the UAVGS 200 utilizes one or more different power connectors and/or the additional connector 328 shown in FIG. 3D.

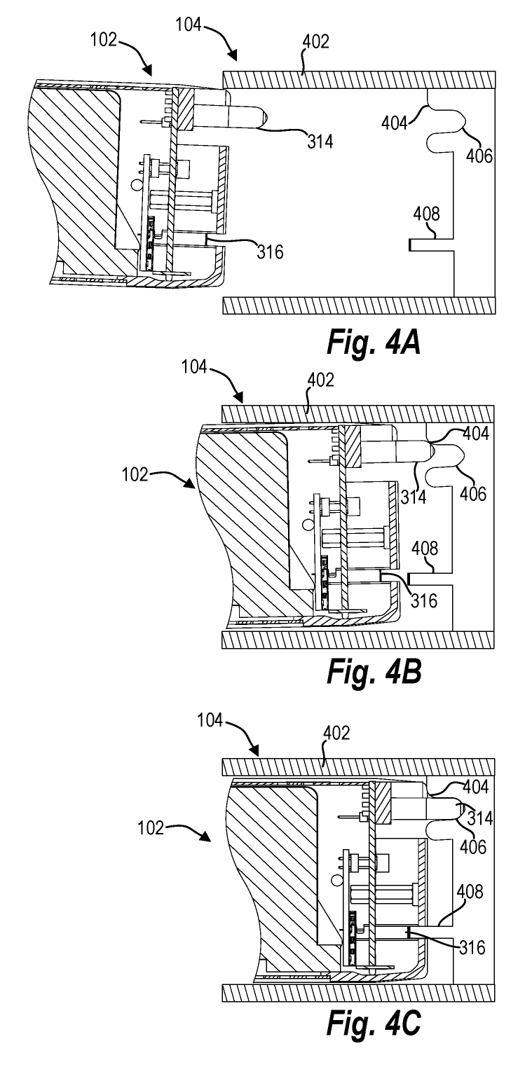

As mentioned above, the self-aligning battery assembly 102 can fit within the receiving slot 104 of the UAV 100 and self-align within the receiving slot 104 as the self-aligning battery assembly 102 is inserted. Additionally, as described herein, the self-aligning battery assembly 102 can incrementally self-align within one or more tolerance levels as different components of the self-aligning battery assembly 102 comes into contact with different components of the receiving slot 104. For example, as shown in FIGS. 4A-4C, the self-aligning battery assembly 102 can self-align within a first tolerance level and a second tolerance level as the self-aligning battery assembly 102 is inserted into the receiving slot 104 of the UAV 100. It is appreciated that the self-aligning battery assembly 102 can similarly self-align within a docking station within the UAVGS 200 that is sized to receive the self-aligning battery assembly 102.

In particular, FIG. 4A shows one example of a self-aligning battery assembly 102 being inserted within a receiving slot 104 of a UAV 100. As shown in FIG. 4A, the self-aligning battery assembly 102 initially comes into contact with a wall 402 of the receiving slot 104 as the self-aligning battery assembly 102 enters an opening of the receiving slot 104. In particular, as shown in FIG. 4A, the alignment rail 312 of the self-aligning battery assembly 102 makes contact with a portion of the wall 402 of the receiving slot 104 and causes the self-aligning battery assembly 102 to self-align within a first tolerance level within the receiving slot 104. Once aligned within the first tolerance level, one or more power connectors 314 can be aligned within an acceptable level of preciseness for the power connectors 314 to establish a connection with a corresponding power contact 406. The first tolerance level, however, may not meet an acceptable level of preciseness for the data connector 316 to establish a connection with a corresponding data contact 408.

Upon aligning within the first tolerance level, the self-aligning battery assembly 102 can continue to slide into the receiving slot 104 of the UAV 100. In particular, as the self-aligning battery assembly 102 continues to be inserted within the receiving slot 104, the power connector 314 can approach a corresponding power contact 406 shaped and sized to receive the power connector 314 until the power connector 314 comes into contact with a portion of the power contact 406. As shown in FIG. 4B, the power connector 314 initially comes into contact with a lip 404 of the power contact 406. As the self-aligning battery assembly continues to slide into the receiving slot 104, the lip 404 causes the self-aligning battery assembly 102 to further self-align from the first tolerance level to within a second tolerance level as the self-aligning battery assembly 102. In particular, the lip 404 can comprise a taper that guides the power connector 314 into alignment as the power connector 314 is inserted within the receiving slot 104. Once aligned within the second tolerance level, the data connector 316 may be aligned within an acceptable level of preciseness for the data connector 314 to establish a connection with the corresponding data contact 408.

FIG. 4B further illustrates that in one or more embodiments, the self-aligning battery assembly 102 and the receiving slot 104 are sized and configured such that the power connector 314 will come into contact with the receiving slot 104 and self align with the receiving slot 104 prior to the data connector 316 coming into contact with the receiving slot. One will appreciate in light of the disclosure herein that this can help prevent damage and wear to the more sensitive data connector 316.

Upon aligning within the second tolerance level, the self-aligning battery assembly 102 can completely insert within the receiving slot 104 of the UAV 100. In particular, as shown in FIG. 4C, the self-aligning battery assembly 102 can fit within the receiving slot 104 within the second tolerance level and establish a secure connection between one or more power connectors 314 and corresponding power contacts 406 as well as between one or more data connectors 316 and corresponding data contacts 408.

Moreover, where FIGS. 3A-4C illustrate embodiments of a self-aligning battery assembly 102 that incrementally aligns within two tolerance levels, it is appreciated that the self-aligning battery assembly 102 an incrementally align in accordance with more than two tolerance levels. For example, in one or more embodiments, the housing 302 of the self-aligning battery assembly 102 includes one or more stages or alignment rails 312 that cause the self-aligning battery assembly 102 self-align within multiple tolerance levels. Additionally or alternatively, the self-aligning battery assembly 102 can include any number of different connector types that are shaped and sized to cause the self-aligning battery assembly 102 to self-align within different tolerance levels as the self-aligning battery assembly 102 is inserted within a receiving slot 104 of the UAV 100.

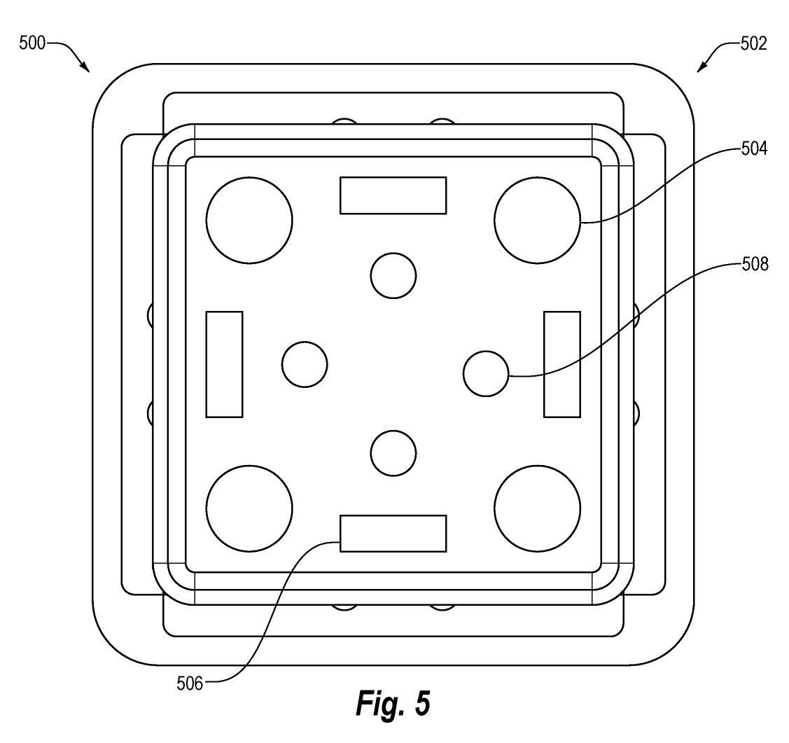

Additionally, while FIGS. 3A-4C illustrate one arrangement of power connectors 314 and data connectors 316, one or more embodiments include a self-aligning battery assembly having different arrangements and configurations of power and data connectors. For example, as shown in FIG. 5, an example embodiment of another embodiment of self-aligning battery assembly 500 that is a dual-connector battery assembly. The self-aligning battery assembly 500 can include a symmetrical arrangement of connectors on a connection end 502 of the self-aligning battery assembly 500.

In one or more embodiments, the connection end 502 of the self-aligning battery assembly 500 forms a square with similar dimensions for each of the sides of the connection end 502. Additionally, as shown in FIG. 5, the connection end 502 of the self-aligning battery assembly 500 includes power connectors 504 having similar features and functionality as the power connectors 314 described above in connection with FIGS. 3A-3D. For example, the power connectors 504 can extend outward from an outer surface of the connection end 502 of the self-aligning battery assembly 500 such that the power connectors 504 engage corresponding power contacts within a receiving slot 104 of a UAV 100 prior to any additional connectors on the self-aligning battery assembly 500 engaging corresponding contacts. Moreover, similar to other connectors described herein, the power connectors 504 can have a shape and size that cause the battery to self-align within a receiving slot (e.g., the receiving slot 104 of the UAV 100).

Additionally, as shown in FIG. 5, the connection end 502 of the self-aligning battery assembly 500 includes one or more data connectors 506 including similar features and functionality as the data connectors 316 described above in connection with FIGS. 3A-3D. For example, the data connectors 506 can extend inward from an outside surface of the connection end 502 of the self-aligning battery assembly 500 and receive a corresponding contact or plug-in to the data connector 506. Alternatively, the data connectors 316 can extend outward from the outside surface of the connection end without extending to the outermost portion of the power connectors 504. As such, the data connectors 506 can engage corresponding data contacts within the receiving slot 104 of the UAV 100 after the power connectors 504 have engaged corresponding power contacts within the receiving slot 104. In one or more embodiments, the data connectors 506 include one or standard USB ports.

Moreover, as shown in FIG. 5, the self-aligning battery assembly 500 includes one or more additional connectors 508 positioned symmetrically across the connection end 502 of the self-aligning battery assembly 500. Each of the connectors 508 can include a customized or standard (e.g., industry standard) connector corresponding to a respective contact within the receiving slot 104 of the UAV 100. In one or more embodiments, the data connectors 506 include a first type of connector while the additional connectors 508 include different types of connectors. For example, in one or more embodiments, the data connectors 506 include a standard USB port while the additional connectors 508 include a jack, plug-in, or other type of connector.

It is appreciated that the different connectors 504, 506, 508 can include any combination of different types of connectors. Additionally, in one or more embodiments, some or all of the connectors 504-508 engage corresponding contacts within a receiving slot 104 of a UAV 100 while some or all of the connectors 504-508 engage corresponding contacts within a similar sized battery dock of a UAVGS 200. For example, when installing the self-aligning battery assembly 500 within a UAV 100, the power connectors 504 and data connectors 506 can engage corresponding contacts within a receiving slot 104 of a UAV 100 without establishing an electrical connection between the additional connectors 508 and the contacts within the receiving slot 104. Additionally, when installing the self-aligning battery assembly 500 within a UAVGS 200, the power connectors 104 and the additional connectors 508 can engage corresponding contacts within the battery dock of the UAVGS 200 without establishing a connection between the data connectors 506 and contacts within the battery dock. It is appreciated that the self-aligning battery assembly 500 can include different combinations of connectors that engage respective contacts within a UAV 100 and/or a UAVGS 200.

As shown in FIG. 5, the various connectors can have a symmetrical arrangement across the connection end 502 of the self-aligning battery assembly 500. For example, in one or more embodiments, the power connectors 504, data connectors 506, and additional connectors 508 have symmetrical positions around the connection end 502 of the self-aligning battery assembly 500. As such, the self-aligning battery assembly 500 can fit within a receiving slot 104 of a UAV without requiring that the self-aligning battery assembly 500 be rotated according to a specific orientation. Because the connectors 504-508 have a symmetrical arrangement, a user or battery arm can conveniently install or plug the self-aligning battery assembly 500 into a receiving slot 104 without requiring that a specific side of the self-aligning battery assembly 500 face up with respect to an orientation of the receiving slot 104 of the UAV 100.

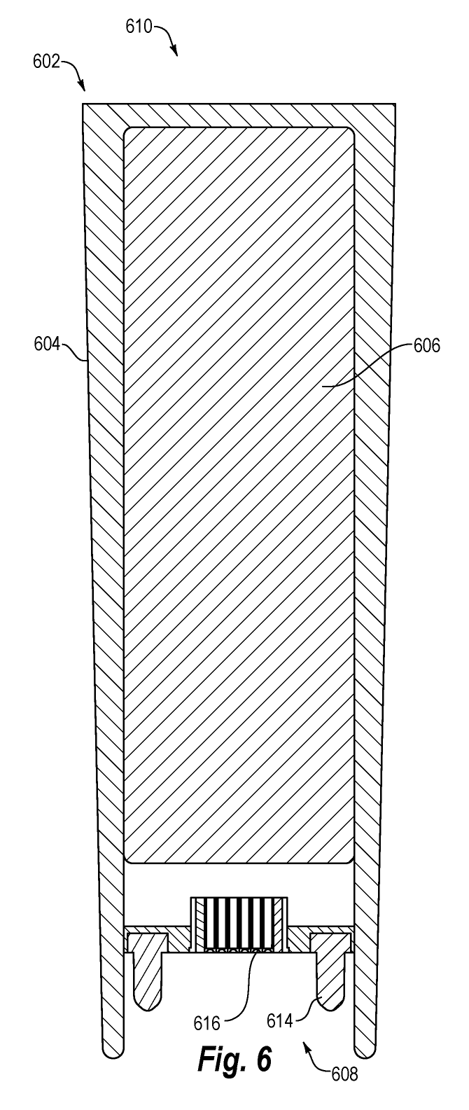

FIG. 6 illustrates another example embodiment of a self-aligning battery assembly 602 including a housing 604 that encloses a battery cell 606. Additionally, as shown in FIG. 6, the self-aligning battery assembly 602 includes one or more power connectors 614 and one or more data connectors 616 positioned on a connection end 608 of the self-aligning battery assembly 602. Each of the housing 604, battery cell 606, power connectors 614, and data connectors 616 can include similar features and functionality as similar components described herein with respect to other figures. Additionally, similar to other embodiments described herein, a user and/or battery arm can install the self-aligning battery assembly 602 within a receiving slot 104 on a UAV 100 and/or a battery dock on a UAVGS 200.

Additionally, as shown in FIG. 6, the housing 604 includes a shape that causes the self-aligning battery assembly 602 to self-align within a receiving slot 104 as the self-aligning battery assembly 602 is inserted within the receiving slot 104. For example, as shown in FIG. 6, the connection end 608 includes one or more dimensions that are smaller than corresponding dimensions at the back end 610 of the self-aligning battery assembly 602. In particular, a width of the housing 604 is wider at the back end 610 than at the connection end 608. As such, as the self-aligning battery assembly 602 inserts into a receiving slot 104 and slides into the receiving slot 104, the gradual change in the width of the housing 604 causes the self-aligning battery assembly 602 to self-align to a more precise alignment between the connectors 614, 616 and corresponding contacts within the receiving slot 104 of the UAV 100. For example, the shape of the housing 604 can cause the self-aligning battery assembly 602 to align within a first tolerance level when the self-aligning battery assembly 602 is inserted within the receiving slot 104 of the UAV 100.

Additionally, as shown in FIG. 6, the power connectors 614 can protrude from an outward surface of the connection end 608 of the self-aligning battery assembly 602. In particular, the power contacts can protrude beyond a point of engagement where the data connector 616 would engage a corresponding contact within the receiving slot 104 of the UAV 100. Additionally, as shown in FIG. 6, rather than extending beyond an outer surface of the housing 604, one or more embodiments of the power connector 614 extend beyond an engagement point of the data connector 616 without extending beyond the connection end 608 of the housing 604. Additionally, as shown in FIG. 6, the data connectors 616 can extend inward from an outer surface of the connection end 608 of the self-aligning battery assembly 602.

FIGS. 1-6, the corresponding text, and the above-discussed examples provide a number of different methods, systems, and devices for replacing a self-aligning battery assembly 102 within a receiving slot 104 of a UAV 100 or, alternatively, within a battery dock of a UAVGS 200. In addition to the foregoing, embodiments can also be described in terms of flowcharts comprising acts and steps in a method for accomplishing a particular result.

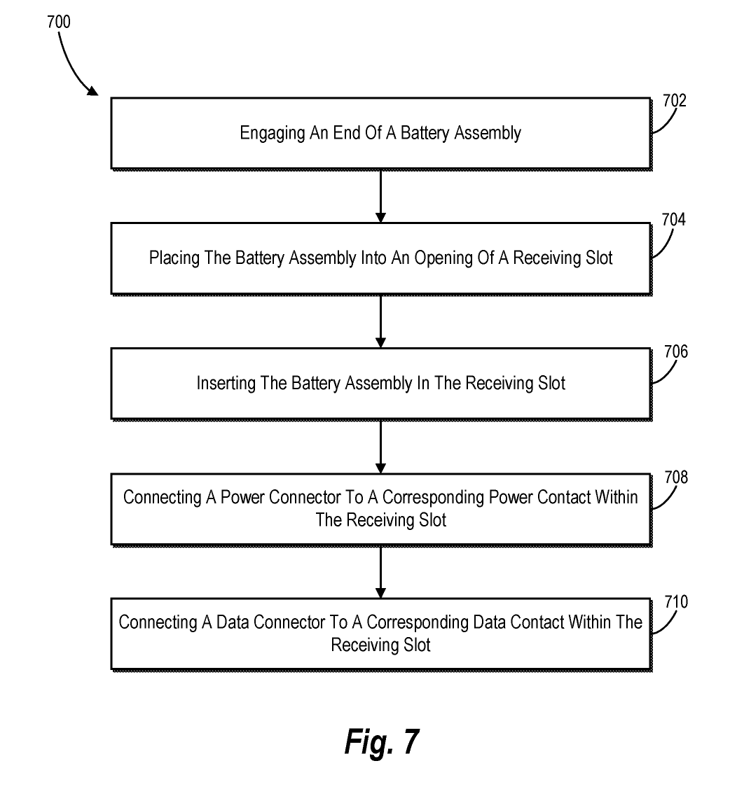

FIG. 7 illustrates a flowchart of one example method 700. One will appreciate that the method 700 may be performed with less or more steps/acts or the steps/acts may be performed in differing orders. Additionally, the steps/acts described herein may be repeated or performed in parallel with one another or in parallel with different instances of the same or similar steps/acts. In one or more embodiments, each step of the method 700 is performed using a battery arm on a UAV ground station 200 (or simply “UAVGS 200”). For example, the battery arm may include a mechanical battery arm onboard a UAVGS 200 that performs each of the steps of the method 700. In one or more embodiments, the battery arm performs one or more steps in accordance with computer-executable instructions and hardware installed on the UAVGS 200.

As shown in FIG. 7, the method 700 can include a process for inserting a dual-connector self-aligning battery assembly 102 (or simply “self-aligning battery assembly 102”) into an unmanned aerial vehicle (UAV) (or simply “UAV 100”). For example, as shown in FIG. 7, the method 700 includes an act 702 of engaging an end of a self-aligning battery assembly 102. For example, engaging the end of the self-aligning battery assembly 102 can involve gripping a handle 310 of a housing 302 of the self-aligning battery assembly 102. Alternatively, in one or more embodiments, gripping the end of the self-aligning battery assembly 102 involves gripping a lip, edge, or other point on the end of the self-aligning battery assembly 102.

The method 700 also includes an act 704 of placing the self-aligning battery assembly 102 into an opening of a receiving slot 104. The receiving slot 104 can include one or more power contacts corresponding to one or more power connectors 314 on the self-aligning battery assembly 102. Additionally, the receiving slot 104 can include one or more data contacts corresponding to one or more data connectors 316 on the self-aligning battery assembly 102. In one or more embodiments, the receiving slot 104 is sized to receive the housing 302 of the self-aligning battery assembly 102.

The method 700 also includes an act 706 of inserting the self-aligning battery assembly 102 into the receiving slot 104. In one or more embodiments, the housing 302 of the self-aligning battery assembly 102 has a shape that causes the self-aligning battery assembly 102 so self-align within a first tolerance level as the battery assembly is inserted within the receiving slot 104. Additionally, the method 700 includes an act 708 of connecting one or more power connectors 314 to corresponding power contacts within the receiving slot 104. In one or more embodiments, the power connectors 314 engage the power contacts when the self-aligning battery assembly 102 aligns within the first tolerance level. In one or more embodiments, connecting the power connectors 314 to the power contacts causes the self-aligning battery assembly 102 to further self align within a second tolerance level that is more precise than the first tolerance level. Further, the method 700 also includes an act 710 of connecting one or more data connectors 316 to corresponding data contacts. In one or more embodiments, the data connectors 316 connect to the data contacts when the self-aligning battery assembly 102 self-aligns within the second tolerance level.

The method 700 can further include one or more additional steps. For example, the method 700 can include an act of extracting a self-aligning battery assembly 102 from the receiving slot 104. In one or more embodiments, extracting the self-aligning battery assembly 102 from the receiving slot 104 involves engaging (e.g., gripping) the end or other portion of the self-aligning battery assembly 102 or housing 302 of the self-aligning battery assembly 102. Engaging the self-aligning battery assembly 102 can further involve pulling the self-aligning battery assembly 102 from the receiving slot 104 while gripping the self-aligning battery assembly 102 and causing the power connectors 314 to disconnect from corresponding power contacts and the data connectors 316 to disconnect from corresponding data contacts.

Additionally, the method 700 can include an act of inserting the self-aligning battery assembly 102 into a battery dock of a UAVGS 200. In one or more embodiments, inserting the self-aligning battery assembly 102 into a battery dock of the UAVGS 200 involves gripping the end of the self-aligning battery assembly 102 by a handle or other portion of the self-aligning battery assembly 102 or battery housing 302. Additionally, inserting the self-aligning battery assembly 102 involves placing the self-aligning battery assembly 102 into an opening of the battery dock of the UAVGS 200 and sliding the self-aligning battery assembly 102 into the battery dock. The battery dock is sized to receive the housing 302 of the self-aligning battery assembly 102.

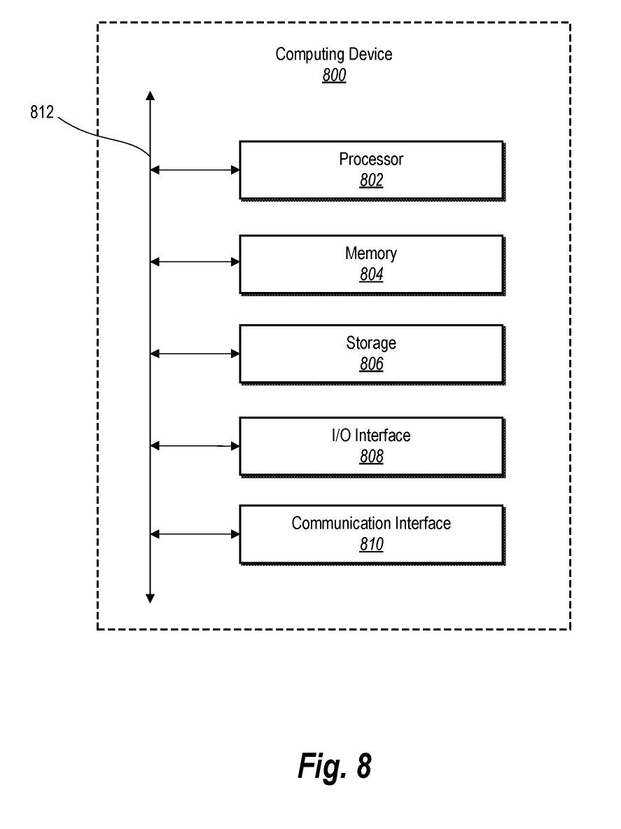

FIG. 8 illustrates a block diagram of exemplary computing device 800 that may be configured to perform one or more of the processes described above (e.g., as described in connection with the UAV 100 or UAVGS 200). As an example, the exemplary computing device 800 can be configured to perform a process for causing a battery arm to insert and/or remove a self-aligning battery assembly 102 from a receiving slot 104 of a UAV 100. Additionally, the computing device 800 can be configured to perform one or more steps of the method 800 described above in connection with FIG. 8. As shown by FIG. 8, the computing device 800 can comprise a processor 802, a memory 804, a storage device 806, an I/O interface 808, and a communication interface 810, which may be communicatively coupled by way of a communication infrastructure 812. While an exemplary computing device 800 is shown in FIG. 8, the components illustrated in FIG. 8 are not intended to be limiting. Additional or alternative components may be used in other embodiments. Furthermore, in certain embodiments, the computing device 800 includes fewer components than those shown in FIG. 8. Components of the computing device 800 shown in FIG. 8 will now be described in additional detail.

In one or more embodiments, the processor 802 includes hardware for executing instructions, such as those making up a computer program. As an example and not by way of limitation, to execute instructions, the processor 802 may retrieve (or fetch) the instructions from an internal register, an internal cache, the memory 804, or the storage device 806 and decode and execute them. In one or more embodiments, the processor 802 includes one or more internal caches for data, instructions, or addresses. As an example and not by way of limitation, the processor 802 may include one or more instruction caches, one or more data caches, and one or more translation lookaside buffers (TLBs). Instructions in the instruction caches may be copies of instructions in the memory 804 or the storage 806.

The memory 804 may be used for storing data, metadata, and programs for execution by the processor(s). The memory 804 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 804 may be internal or distributed memory.

The storage device 806 includes storage for storing data or instructions. As an example and not by way of limitation, storage device 806 can comprise a non-transitory storage medium described above. The storage device 806 may include a hard disk drive (“HDD”), a floppy disk drive, flash memory, an optical disc, a magneto-optical disc, magnetic tape, or a Universal Serial Bus (“USB”) drive or a combination of two or more of these. The storage device 806 may include removable or non-removable (or fixed) media, where appropriate. The storage device 806 may be internal or external to the computing device 800. In one or more embodiments, the storage device 806 is non-volatile, solid-state memory. In other embodiments, the storage device 806 includes read-only memory (“ROM”). Where appropriate, this ROM may be mask programmed ROM, programmable ROM (“PROM”), erasable PROM (“EPROM”), electrically erasable PROM (“EEPROM”), electrically alterable ROM (“EAROM”), or flash memory or a combination of two or more of these.

The I/O interface 808 allows a user to provide input to, receive output from, and otherwise transfer data to and receive data from computing device 800. The I/O interface 808 may include a mouse, a keypad or a keyboard, a touch screen, a camera, an optical scanner, network interface, modem, other known I/O devices or a combination of such I/O interfaces. The I/O interface 808 may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 808 is configured to provide graphical data to a display for presentation to a user. The graphical data may be representative of one or more graphical user interfaces and/or any other graphical content as may serve a particular implementation.

The communication interface 810 can include hardware, software, or both. In any event, the communication interface 810 can provide one or more interfaces for communication (such as, for example, packet-based communication) between the computing device 800 and one or more other computing devices or networks. As an example and not by way of limitation, the communication interface 810 may include a network interface controller (“NIC”) or network adapter for communicating with an Ethernet or other wire-based network or a wireless NIC (“WNIC”) or wireless adapter for communicating with a wireless network, such as a WI-FI.

Additionally or alternatively, the communication interface 810 may facilitate communications with an ad hoc network, a personal area network (“PAN”), a local area network (“LAN”), a wide area network (“WAN”), a metropolitan area network (“MAN”), or one or more portions of the Internet or a combination of two or more of these. One or more portions of one or more of these networks may be wired or wireless. As an example, the communication interface 810 may facilitate communications with a wireless PAN (“WPAN”) (such as, for example, a BLUETOOTH WPAN), a WI-FI network, a WI-MAX network, a cellular telephone network (such as, for example, a Global System for Mobile Communications (“GSM”) network), or other suitable wireless network or a combination thereof.

Additionally, the communication interface 810 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

The communication infrastructure 812 may include hardware, software, or both that couples components of the computing device 800 to each other. As an example and not by way of limitation, the communication infrastructure 812 may include an Accelerated Graphics Port (“AGP”) or other graphics bus, an Enhanced Industry Standard Architecture (“EISA”) bus, a front-side bus (“FSB”), a HYPERTRANSPORT (“HT”) interconnect, an Industry Standard Architecture (“ISA”) bus, an INFINIBAND interconnect, a low-pin-count (“LPC”) bus, a memory bus, a Micro Channel Architecture (“MCA”) bus, a Peripheral Component Interconnect (“PCI”) bus, a PCI-Express (“PCIe”) bus, a serial advanced technology attachment (“SATA”) bus, a Video Electronics Standards Association local (“VLB”) bus, or another suitable bus or a combination thereof.

In the foregoing specification, the present disclosure has been described with reference to specific exemplary embodiments thereof. Various embodiments and aspects of the present disclosure(s) are described with reference to details discussed herein, and the accompanying drawings illustrate the various embodiments. The description above and drawings are illustrative of the disclosure and are not to be construed as limiting the disclosure. Numerous specific details are described to provide a thorough understanding of various embodiments of the present disclosure.

The present disclosure may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

What is claimed is:

1. A self-aligning battery assembly for an unmanned aerial vehicle (UAV), comprising:
a housing having a first end and a second end, the housing being sized to fit into a receiving slot of the UAV, wherein the housing has a shape that causes the housing to self-align within the receiving slot within a first tolerance level when the housing is inserted into the receiving slot;
a power connector positioned at a first end of the housing, the power connector sized to engage with a corresponding power contact within the receiving slot of the UAV, wherein the power connector has a shape that causes the housing to self-align from the first tolerance level to a second tolerance level when the power connector engages the corresponding power contact when the housing is inserted into the receiving slot; and
a data connector positioned at the first end of the housing, the data connector sized to engage a corresponding data contact within the receiving slot of the UAV, wherein the data connector is positioned to engage the corresponding data contact when the housing self-aligns within the second tolerance level when the housing is inserted into the receiving slot.

2. The self-aligning battery assembly as recited in claim 1, wherein the first tolerance level is less precise than the second tolerance level.

3. The self-aligning battery assembly as recited in claim 2, wherein the first tolerance level is less precise by a factor of ten or more than the second tolerance level.

4. The self-aligning battery assembly as recited in claim 1, wherein a dimension of the housing at the first end of the housing is less than a corresponding dimension of the housing at the second end of the housing.

5. The self-aligning battery assembly as recited in claim 4, wherein the shape of the housing comprises a gradual change between the dimension of the housing at the first end of the housing to the corresponding dimension of the housing at the second end of the housing.

6. The self-aligning battery assembly as recited in claim 4, wherein the shape of the housing comprises a change between the dimensions of the housing at the first end to the corresponding dimension of the housing at the second end, the change in between the dimensions occurring toward the first end of the housing.

7. The self-aligning battery assembly as recited in claim 1, wherein the power connector protrudes from an outward surface of the first end of the housing.

8. The self-aligning battery assembly as recited in claim 7, wherein the power connector protrudes from the outward surface of the first end of the housing beyond a point of engagement of the data connector.

9. The self-aligning battery assembly as recited in claim 1, wherein the data connector forms a recess in an outer surface of the first end of the housing.

10. The self-aligning battery assembly as recited in claim 1, wherein the data connector comprises a universal serial bus (USB) port.

11. The self-aligning battery assembly as recited in claim 1, wherein the power connector provides power to a camera component and a flying component of the UAV.

12. The self-aligning battery assembly as recited in claim 1, wherein the shape of the housing causes the housing to self-align within the receiving slot within the first tolerance level without forming an electrical connection between the power connector and the corresponding power contact or the data connector and the corresponding data contact.

13. The self-aligning battery assembly as recited in claim 1, further comprising one or more additional power connectors sized to engage one or more additional corresponding power contacts within the receiving slot of the UAV.

14. An unmanned aerial vehicle (UAV) system comprising:
a main body;
one or more rotors coupled to the main body;
at least one camera coupled to the main body;
a receiving slot within the main body, the receiving slot comprising:
an opening at a first end of the receiving slot, the opening being sized to receive a battery assembly;
an interior portion of the receiving slot, the interior portion shaped to cause the battery assembly to self-align within a first tolerance level when the battery assembly is inserted into the receiving slot.
a power contact at a second end of the receiving slot, the power contact positioned within the receiving slot to receive a power connector on the battery assembly when the battery assembly aligns within the first tolerance level, wherein the power contact further causes the battery assembly to self-align within a second tolerance level when the battery assembly is inserted into the receiving slot; and
a data contact at the second end of the receiving slot, the data contact positioned within the receiving slot to engage a data connector on the battery assembly when the battery assembly aligned within the second tolerance level.

15. The UAV system as recited in claim 14, further comprising:
a landing system coupled to the main body; and
a UAV ground station (UAVGS) having a receiving cone shaped to receive the landing system.

16. The UAV system as recite in claim 15, wherein the UAVGS comprises one or more battery docks shaped to receive the battery assembly.

17. The UAV system as recited in claim 16, wherein the one or more battery docks on the UAVGS are shaped to cause the battery assembly to self-align when the battery assembly is inserted within the one or more battery docks on the UAVGS.

18. A method for replacing a dual-connector battery assembly for an unmanned aerial vehicle (UAV), the method comprising:
engaging an end of a battery assembly, the battery assembly comprising a power connector and a data connector positioned on a first end of the battery assembly;
placing the battery assembly into an opening of a receiving slot, the receiving slot having a power contact corresponding to the power connector and a data contact corresponding to the data connector, wherein the receiving slot is sized to receive the housing of the battery assembly;
inserting the battery assembly into the receiving slot, wherein a shape of the housing causes the battery assembly to self-align within a first tolerance level as the battery assembly is inserted within the receiving slot; and
when the battery assembly is aligned within the first tolerance level, connecting the power connector to the corresponding power contact, wherein connecting the power connector to the corresponding power contacts causes the battery assembly to further self-align from within the first tolerance level to within a second tolerance level;
when the battery assembly is aligned within the second tolerance level, connecting the data connector to the corresponding data contact.

19. The method as recited in claim 18, further comprising:
extracting the battery assembly from the receiving slot, wherein extracting the battery assembly from the receiving slot comprises:
gripping the end of the battery assembly; and
pulling the battery assembly from the receiving slot, wherein pulling the battery assembly from the receiving slot causes the data connector to disconnect from the corresponding data contact and the power connector to disconnect from the corresponding power contact;

20. The method as recited in claim 19, further comprising:
inserting the battery assembly into a receiving slot on a UAV ground station (UAVGS), inserting the battery assembly into a receiving slot on the UAVGS comprises:
gripping the end of the battery assembly;
placing the battery assembly into an opening of the receiving slot of the UAVGS, the receiving slot of the UAVGS sized to receive the housing of the battery assembly.
